(19) United States
(12) Patent Application Publication
(10) Pub. No.: US 2022/0092064 A1
(43) Pub. Date: Mar. 24, 2022

(54) SAMPLE PAIR SELECTION IN ENTITY MATCHING ANALYSIS

(71) Applicant: International Business Machines Corporation, Armonk, NY (US)

(72) Inventors: Lars Bremer, Boeblingen (DE); Martin Oberhofer, Sindelfingen (DE); Thuany Karoline Stuart, Aachen (BR); Claudio Andrea Fanconi, Celerina (CH); Jonathan Roesner, Leimersheim (DE); Daniel Suski, Leonberg (DE)

(21) Appl. No.: 17/026,352

(22) Filed: Sep. 21, 2020

(51) Int. Cl. G06F 16/2458; G06F 16/242; G06F 16/28

(52) U.S. Cl. CPC G06F 16/2462; G06F 16/248; G06F 16/285; G06F 16/244

(57) ABSTRACT

Selecting entity matching systems sample record pairs by selecting at least one first record pair from entity matching system data records, scoring attribute compare methods of the at least one first record pair according to the entity matching system, adding the at least one first record pair to a no-match set according to the attribute matching score, selecting at least one second record pair from an entity matching system data record bucket, scoring attribute compare methods of the at least one second record pair according to the entity matching system, adding the at least one second record pair to record pair set, according to the second record pair attribute compare method score, and providing the record pair set to a user.

### BACKGROUND

The disclosure relates generally to record pair selection in entity matching systems. The disclosure relates particularly to selecting sample record pair data according to record pair anomalies.

Data management systems collect records coming from various sources, match the records' information (such as Name, Address, Identifiers etc.) using probabilistic matching features, and generate a cumulative score indicative of the degree of matching between the record pair. Matching record pair data requires comparing different record attribute values (e.g., Name, Address, Identifiers, etc.) from each pair of records to determine if they match and if they should subsequently be linked, based on a series of mathematically derived statistical probabilities and complex weight tables.

Attribute comparison functions check for a variety of matching conditions such as exact, edit distance, N-GRAM, phonetic, or partial matching. Scores are generated based on the outcome of these comparisons, and sub scores from each attribute are combined based on statistically determined relative weights. Using statistically defined thresholds within the system, pairs of records are considered as matched, unmatched, or indeterminant and sent to Clerical Review.

Scores over a threshold, called Autolink (AL), indicate both of the records are the same. Scores below another threshold, called Clerical Review (CR), indicate the records are different. Scores falling between the AL and CR thresholds are indeterminant and need a manual intervention by a data steward to determine if the records are the same or different.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable the analysis of data management entity matching systems.

Aspects of the invention disclose methods, systems and computer readable media associated with selecting entity matching systems sample record pairs by selecting at least one first record pair from entity matching system data records, scoring attribute compare methods of the at least one first record pair according to the entity matching system, adding the at least one first record pair to a no-match set according to the attribute matching score, selecting at least one second record pair from an entity matching system data record bucket, scoring attribute compare methods of the at least one second record pair according to the entity matching system, adding the at least one second record pair to record pair set, according to the second record pair attribute compare method score, and providing the record pair set to a user.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 provides an exemplary user interface, according to an embodiment of the invention.

FIG. 4 depicts a cloud computing environment, according to an embodiment of the invention.

FIG. 5 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

In an embodiment, one or more components of the system can employ hardware and/or software to solve problems that are highly technical in nature (e.g., randomly selecting record pairs from the set of entity matching system data records, scoring attribute compare methods of the record pairs according to the entity matching system, adding record pairs having a no-operation attribute compare method score to a no-match set, selecting at least one second record pair from an entity matching system data record bucket, scoring attribute compare methods of the bucketed record pair according to the entity matching system, adding the bucketed second record pair to at least one of a match set, clerical set, or the no-match set, according to the bucketed record pair attribute compare method score, and providing the no-match set, clerical set, and match set to a user, where such steps are performed across millions or billions of entity matching system data records, etc.). These solutions are not abstract and cannot be performed as a set of mental acts by a human due to the processing capabilities needed to facilitate data management system performance analysis, for example. Further, some of the processes performed may be performed by a specialized computer for carrying out defined tasks related to memory operations. For example, a specialized computer, or computing environment system, can be employed to carry out tasks related to data management record matching performance, or the like.

A PME: “probabilistic matching engine”, refers to the engine used for comparison of records of a data management data set.

Once a data management database is populated with its core member data, the derivation process, which involves standardizing the incoming data, bucketing the data, and generating additional comparison data to compare data across sources, occurs. Standardization is the resolution of certain attributes within the data to a common format. During the bucketing process that follows, records that have similar values for a defined set of attributes are grouped together in buckets. The attributes defining the buckets are identified during the initial configuration of a data management server by the project team. Typically, a solution requires about five to seven buckets per member and each bucket definition can contain one or more attributes. Examples of buckets might be [first name], [last name and zip code] and [street name]. The final step in the derivation process is the generation of additional comparison data which is extracted from the core data. Both comparison data and bucket data are stored separately in a derived data layer. Bucket data is used in the candidate selection process, and candidate comparison data is used when comparing two specific members. Both concepts are required to make similarity checks fast and efficient.

After configuring a data management solution, it is important for the business (data stewards, data owners) to be confident a good configuration was found and the system is making the correct matching decisions (auto-link, clerical review, no-operation).

To gain this confidence a list of sample comparisons needs to be identified. The data stewardship team evaluates these comparisons by making the same decisions that the matching engine would perform (auto-link, clerical review, no-operation). Afterwards, they compare the matching engine results with the assessments of the data stewards. If both assessments are the same on the sample data, the configuration can be considered correct and be used in production.

One key aspect to gain the confidence that the configuration is working as intended is the quality of the sampling pairs. It is imperative that the selection of samples is showing a wide range of comparisons with different properties. Only then can the stewardship team be certain the configuration of the matching engine works well for most of the data in the system.

Typical configuring matching today requires deep subject matter expertise and follows the Sample Pair process which roughly works as follows: a PME expert configures initial configuration of a PME and runs that PME configuration against the full data set. There is at least one algorithm per domain required (person, org, location, product, householding, etc.)—possibly more (lead vs. active customers are matched differently). For example, a source with very high data quality and 20 million records could result in 19 million non-matches, 200,000 clericals (2 or more records per task—assuming an average of 3 meaning 600,000 records are in this group) and 400,000 auto-matches. From these, the PME expert selects >1,000 data points across all 3 groups for review with a business user if the match results are accurate.

A first review with the business users typically reveals that within the >1,000 data points selected, some results are correct, and some results are wrong and belong into a different group. The PME expert asks for the reasons why to understand what needs to be changed in PME configuration. Tuning of the PME and a re-run yields a 2nd result.

The PME expert reviews the data points of the 2nd result with business users again to find out if now >1,000 data points are all in the correct group and, if not, which ones need to be in a different group and why they should be there. Tuning of the PME and another re-run yields a 3rd result.

The PME expert reviews the data points of the 3rd result with business users again to find out if now >1,000 data points are all in the correct group and, if not, which ones need to be in a different group and why they should be there. Tuning of the PME and another re-run yields a 4th result. By this time, for the >1,000 data points, the results are expected to be in the right group. The PME expert conducts a final review and sign-off with business user to confirm that this is now the correct configuration.

Disclosed systems and methods enable sampling the pairs having a wide range of comparisons with different properties by classifying record pairs as no-match, clerical, or match pairs, further identifying outlier records pairs—those classified pairs having anomalous attribute compare method scores for their classification—and identifying record pairs among clusters of classified record pairs, where the clusters are defined according to patterns in attribute compare method scores.

The system includes two components, a selection component and a user interface. The selection component interacts with the data management system to sample a subset of the possible pairwise comparisons of the records stored in the database. The selection component uses the comparison data the matching engine returns. The comparison data includes an overall similarity score for the record pair as well as detailed data about the similarity of individual attributes of the two compared records.

The user interface shows the pairwise comparisons including information regarding why this pair was selected and why the pair is important. This information gives the end-user confidence that the selected pairs represent the entire dataset precisely enough in order to decide if the prediction quality of the configured matching engine is sufficient. For each pair the disclosed methods show the assessment of the configured matching engine and allow the data stewards to add their assessments.

In an embodiment, the method executes a selection process in multiple sequential steps. Each step identifies a set of comparisons with different properties. In this embodiment, the sample sets include:

No-match: This set includes comparisons for which the matching engine has high certainty that the records do not match. This set provides confidence that the matching engine is not overly pessimistic with matching records—that the matching engine is not generating false negatives (records classified as no-match which do, in fact, match).

Match: This set includes comparisons for which the matching engine has high certainty that the record pair matches and references the same real-world object. This set provides confidence that the matching engine is not overly optimistic with matching records—that the matching engine is not generating false positives (records classified as matching which in fact, do not match).

Clerical: This set includes comparisons that require a review of a data steward. This set provides confidence the matching engine does not take an automatic decision when it is not certain.

Outliers: This set includes record comparisons across the no-match, clerical, and match sets that are different than most of the others. It is important to have an individual set for them as they might be easily overlooked otherwise. An outlier could be a comparison where all attributes of the two compared records are very similar (or even identical) except for the social security number—this is very uncommon.

Clusters: This set includes comparisons that occur often in a similar form. Clusters require review because getting all the comparisons of a cluster (which can number in the multiple tens of thousands of record pairs) wrong has a potentially huge impact on the overall data quality. For example, assuming a country's social security number has a checksum number in the end, and a common data entry error includes omission of this data. Subsequent comparison of a record (incl. the checksum) to a record that was added incorrectly without the checksum would yield an edit distance of 1 (indicating no-match). These types of errors may happen thousands of times. Clustering record pairs according to attribute compare method score patterns predicts these situations and chooses records from such clusters (groups) in the selection process, for review by the user.

In an embodiment, after records are entered into the data management data set, the method randomly selects a first record pair from among a portion of the data management records, up to and including from among all the data management records. The method scores the record pair according to the attribute compare methods of the entity matching system. In an embodiment, the attribute compare method scores may be derived from comparisons of feature vectors generated for each underlying record of the pair of records. Record attributes may have weights assigned to them according to the significance of each attribute in supporting a match or indicating an unmatched state, or an indeterminant (CR) state, for the pair. Attribute weights may be adjusted according to relative contributions made by each attribute in support of a matched status across a set of record comparisons among the data management system data. The frequency with which particular attributes are associated with matched record pair determination may also affect attribute weighting and overall record pair comparison scores. Other known attribute compare method scoring processes may be used in scoring the randomly selected record pairs.

The method considers the attribute compare method scores of the randomly selected record pair. The method adds record pairs having no-operation scores—scores falling below the established CR threshold—to the no-match set of record pairs. The method tracks the specific attributes of the record pair contributing to the no-operation score for inclusion in the output to the user for review. Providing the attribute level scoring for the record pair enables the user to evaluate whether the record pair classified by the entity matching engine as no-match, constitutes a false negative. The no-match may be large. The method need not present all no-match records to a user for review. In an embodiment, the method presents a subset, such as 100 records, of the no-match set to the user.

In an embodiment, the method selects a second record pair from the bucketed data records of the data management data set. The method may select one or more record pairs from each defined data bucket. As described above, the bucketed data records have similar values for a defined set of one or more attributes. In this embodiment, the method evaluates the attribute compare method scores for the selected pair of bucketed records. For each evaluated bucketed record pair, the method classifies the record pair as either no-match, for pairs having scores falling below the CR threshold, clerical, for pairs having scores equal to or between the CR and AL thresholds, and match, for pairs having scores above the AL threshold.

In this embodiment, the method selects bucketed record pairs from across the defined data management data record buckets. In this embodiment, the method selects a number of records from each bucket according to a default selection number, such as 100 records per bucket.

In an embodiment, the method combines the first record pairs added to the no-match set with the bucketed record pairs classified as no-match, clerical, or match sets. The method evaluates the combined set of record pairs to identify anomalies. Anomalous record pairs include pairs having high anomaly scores under a method such as an unsupervised learning algorithm including an isolation forest, indicating that the pattern of detailed attribute compare method scores for the identified record differs from the typical score pattern for the record pairs in the same set. In this embodiment, the method classifies all record pairs having isolation forest—or other anomaly detection algorithm—scores above a threshold as outliers. In this embodiment, the method uses a default threshold for the anomaly score, selects only the highest anomaly score for each classification set, selects a defined percentage of all set members according to their anomaly algorithm score, or selects a defined portion of the anomaly algorithm score distribution, as the outlier set. In this embodiment, the method provides the details of the attribute compare method scores for each classified outlier for user review.

In an embodiment, the method adjusts attribute compare methods according to anomalies. As an example, the method notes that record pairs having mis-matched social security checksum values are not matched, even though review of the other record pair attribute compare methods indicate that the record pairs should be matched. The method may suggest that social security checksum be removed from the set of attribute compare methods used for matching.

In an embodiment, the method evaluates the classified sets of records to identify clusters of records. In this embodiment, the method uses a clustering algorithm, such as k-means—to identify patterns of attribute compare method scores across the respective sets of record pairs. As described above, clusters include sets of records having similar attribute compare method score patterns and assist a user in identifying large sets of common data entry errors which skew entity matching engine performance. In this embodiment, the method selects one or more from each cluster for review by the user. In this embodiment, the method also provides the user the attribute compare method score details for each selected cluster pair. In an embodiment, the method selects record pairs from only the largest clusters, those clusters which together, comprise a majority of the clustered record pairs. In an embodiment, the method selects two record pairs from each cluster.

In an embodiment, the method provides the no-match, clerical, and match sets of selected record pairs to a user for review. In an embodiment, the method further provides the outlier set, the cluster set, or both the outlier and cluster sets of record pairs for review. In an embodiment, the method provides detailed attribute compare method scores for each provided record pair, enabling the user to determine the underlying basis for the current classification of each record pair.

In an embodiment, the method provides the selected records through a graphical user interface (GUI). In this embodiment, the GUI provides each classified set, the total number of set members, and affords the user an ability to access and review the underlying data—the record pairs and associated attribute compare method scores—of each provided set. In this embodiment, as data steward review of the provided record sets proceeds, the method updates the GUI data for each classified set to include the level of agreement between the entity matching engine classification and the data steward classification. As an example, data steward review of the selected set of no-match records may result in agreement between the entity matching engine classification and the data steward classification, 82% for 82% of the selected no-match set records. In this embodiment, the GUI reflects the levels of data steward and entity matching engine agreement. Providing this information enables a user to identify deficient aspects of the entity matching engine classification algorithms—those aspects having higher than acceptable levels of data steward and entity matching engine disagreement.

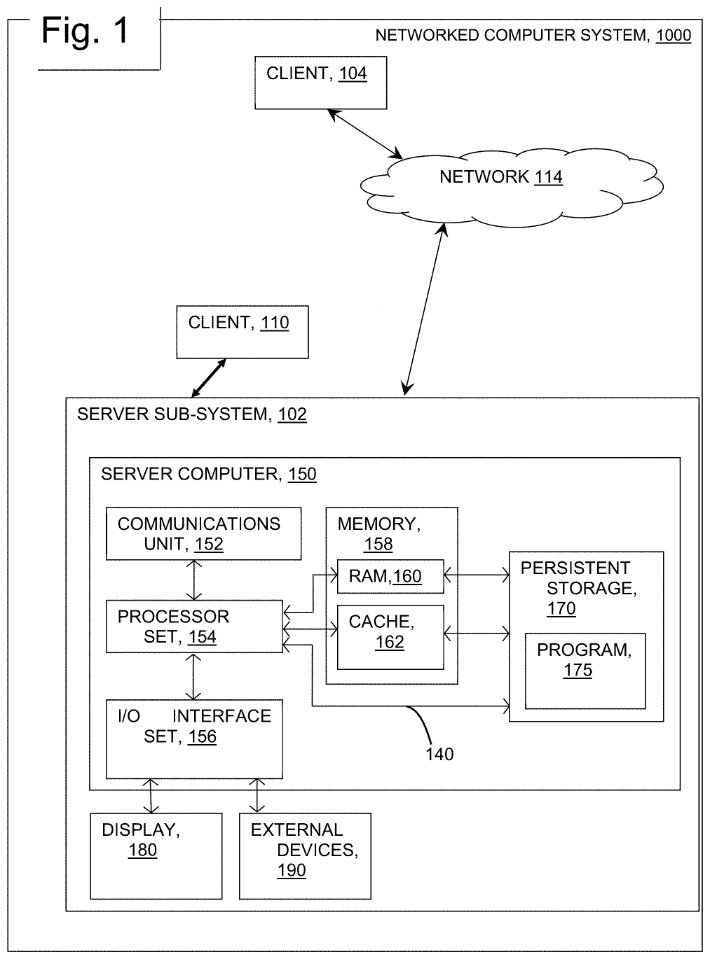

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise matching system analysis program (not shown) together with sufficient computing resource (processor, memory, network communications hardware) to execute the program. In an embodiment, client devices 104 and 110 constitute portions of a data management system for matching entities across networked resources. As shown in FIG. 1, server sub-system 102 comprises a server computer 150 associated with the data management system and matching entities. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment can be made.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158. In an embodiment, memory 158 stores data management records and their associated entity matching data.

Program instructions and data used to practice embodiments of the present invention, e.g., matching system analysis program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110, edge cloud, and cloud resource (not shown). In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152. Communications unit 152 enables user interactions with the data management system and for the disclosed embodiments, the matching system analysis program 175.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., matching system analysis program 175 on server computer 150, can be stored on such portable computer readable storage media and can be loaded onto persistent storage 170 via I/O interface(s) 156. I/O interface(s) 156 also connect to a display 180. Data management records and user requests and feedback pass through I/O interface 156.

Display 180 provides a mechanism to display data to a user and may be, for example, a computer monitor. Display 180 can also function as a touch screen, such as a display of a tablet computer.

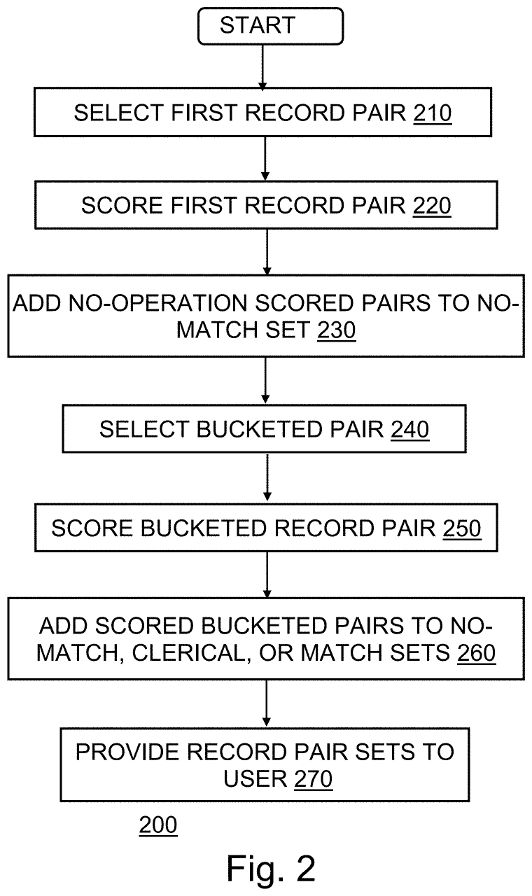

FIG. 2 provides a flowchart 200, illustrating exemplary activities associated with the practice of the disclosure. After program start, at block 210, the method of matching system analysis program 175, of FIG. 1, selects first record pairs from among a portion of the set of data management data records, up to and including the full set of data management data records. The method randomly selects record pairs without regard to attribute compare method scores or other relationships between the records of the pairs.

At block 220, the method scores the selected first record pairs using the entity matching engine scoring algorithms. As an example, the method utilizes a scoring system based upon differences between vector representations of each record of each selected pair.

At block 230, the method classifies selected pairs which have no-operation attribute compare method scores below a defined clerical review threshold, as no-match record pairs, and adds these pairs to a no-match record pair set.

At block 240, the method selects bucketed record pairs from defined data management data buckets. In an embodiment, the method selects bucketed record pairs from each defined data management data bucket. Defined data bucket record pairs include similar values for the attributes of the respective bucket definition.

At block 250, the method applies the entity matching engine scoring algorithm to the selected bucketed record pairs as described above. At block 260, the method classifies the scored bucketed record pairs as one of: no-match, clerical review, or match according to the attribute compare method scores of the record pair and adds the record pairs to the respective record pair sets. In an embodiment, the method selects and categorizes record pairs such that about 100 record pairs from each category are available for user review. A user may provide input to increase or decrease the number of pairs for review in each category.

At block 270, the method provides a user with the classified sets of no-match, clerical review, and match record pairs, together with the details of the attribute compare method scores for each provided record.

In an optional step, not shown, the method reviews all provided records using an anomaly detection algorithm, such as an isolation forest, or other anomaly detection algorithm, and classifies a portion of the reviewed record pairs as outliers, adding them to an outlier set of record pairs. The method classifies record pairs from each defined set as outliers and may classify only the record pair having the highest anomaly algorithm score from each set as an outlier, may classify a percentage of each set as outliers according to the score, or may select a defined portion of each set's outlier score distribution, as outliers. The method provides outliers and their associated attribute compare method score details to the user.

In an optional step, not shown, the method clusters the provided no-match, clerical, and match sets of data records, according to patterns in the attribute compare method scores of the records of each respective set. The method selects one or more record pairs from at least the largest cluster, or from each cluster, or from each cluster including a defined percentage of the overall set of provided record pairs, for presentation to the user. The selected clustered record pairs are provided together with their associated attribute compare method scores details for review by the user.

In an embodiment, the method receives feedback from the user relating to the accuracy of the classification of each provided record pair. In this embodiment, the method aggregates the feedback and provides the user an indication of the accuracy of the entity matching engine for each provided set of record pairs—e.g., the method provides an accuracy for each of the no-match, clerical, match, outlier, and each cluster.

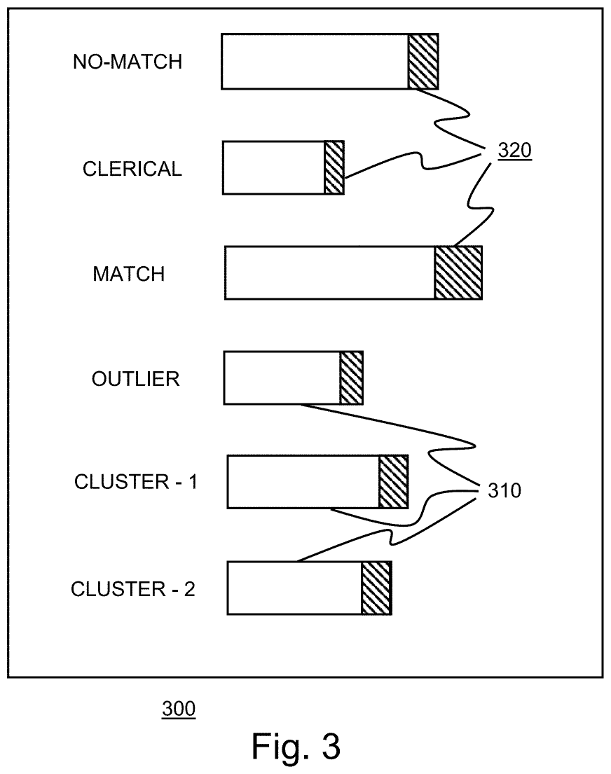

FIG. 3 provides a stylized example of a user interface 300, according to an embodiment of the invention. As shown in the figure, bars 310 represent the total record pairs of each classification set: no-match, clerical, match, outliers, cluster-1, and cluster-2. In the figure the lengths of the bars are relative to the number of record pairs in each classification set. Hatched bars 320, within each bar 310, represent the number of records where the data steward and entity matching engine disagreed upon the classification. Again, the length of each hatched bar 320 is relative to the number of relevant record pairs. In an embodiment, not shown, the method displays the actual number of record pairs in each classification set within the interface, adjacent to the relevant bars. In an embodiment, a user may click, or otherwise select, a classification by name or by the presented graphic bar, to bring up the underlying record pair attributes and attribute compare method scores for the selected classification set.

Data management systems may include large data sets (big data) and may be distributed across complex networked computing environments including both local networks as well as edge cloud and cloud network resources. As data management datasets grow, ongoing evaluation of the current matching process parameters requires review of ever larger sets of previously matched pairs. Disclosed embodiments reduce the resource burden associated with such reviews by providing sets of record pairs from no-match, clerical, and match regions as well as providing outlier records associated with each region and record pairs from clusters of common attribute compare method scoring patterns. The disclosed embodiments provide a user with the sets of records as well as indications of the scoring patterns which resulted in the respective classifications of the records.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

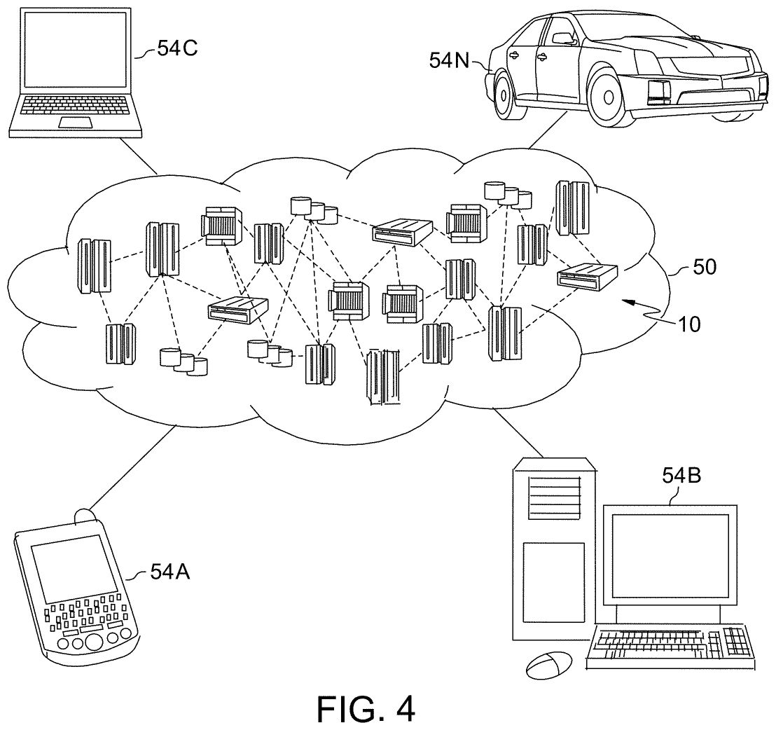

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

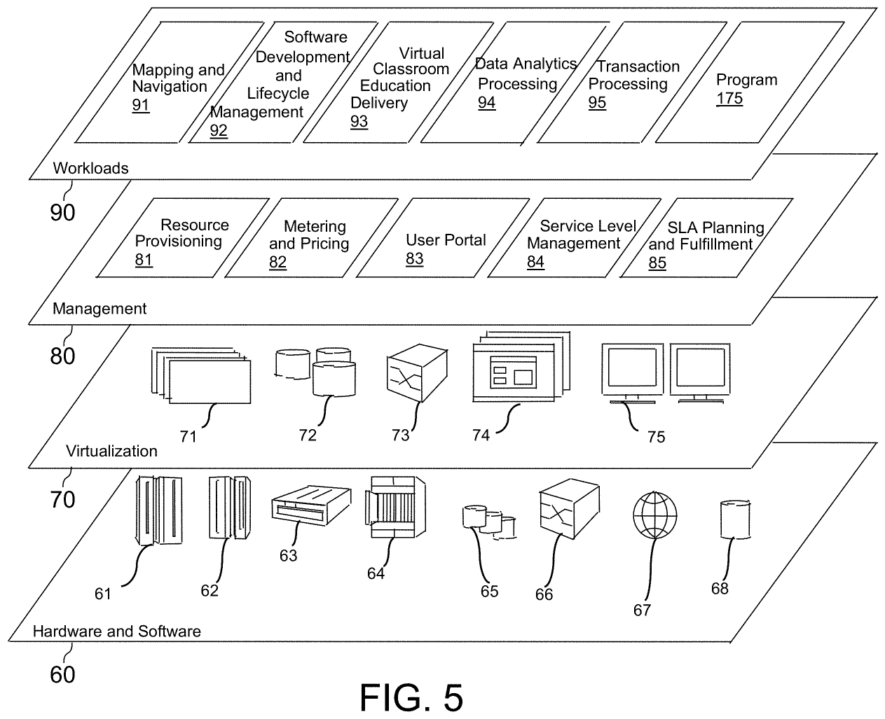

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and matching system analysis program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for selecting entity matching system sample record pairs, the method comprising:
selecting, by one or more computer processors, at least one first record pair from entity matching system data records;
scoring, by the one or more computer processors, attribute compare methods of the at least one first record pair according to the entity matching system;
adding, by the one or more computer processors, the at least one first record pair to a no-match set according to the attribute compare method score;
selecting, by the one or more computer processors, at least one second record pair from an entity matching system data record bucket;
scoring, by the one or more computer processors, attribute compare methods of the at least one second record pair according to the entity matching system;
adding, by the one or more computer processors, the at least one second record pair to a record pair set, according to the second record pair attribute compare method score; and
providing, by the one or more computer processors, the record pair set to a user.

2. The computer implemented method according to claim 1, further comprising:
identifying, by the one or more computer processors, an anomalous record pair among the at least one first record pair and at the least one second record pair;
adding, by the one or more computer processors, the anomalous record pair to an outlier set; and
providing, by the one or more computer processors, the outlier set to the user.

3. The computer implemented method according to claim 1, further comprising:
grouping, by the one or more computer processors, the at least one first record pair and the at least one second record pair into clusters according to attribute comparison scores;
adding, by the one or more computer processors, at least two record pairs from a cluster to a cluster set; and
providing, by the one or more computer processors, the cluster set to the user.

4. The computer implemented method according to claim 1, further comprising adding, by the one or more computer processors, a second record pair having an attribute compare score above an autolink threshold to a match set.

5. The computer implemented method according to claim 1, further comprising adding, by the one or more computer processors, a second record pair having an attribute compare score above a clerical threshold and below an autolink threshold to a clerical set.

6. The computer implemented method according to claim 1, further comprising adding, by the one or more computer processors, a second record pair having an attribute compare score below a clerical threshold to the no-match set.

7. The computer implemented method according to claim 1, further comprising:
identifying, by the one or more computer processors, an anomalous record pair among the at least one first record pair and the at least one second record pair;
adding, by the one or more computer processors, the anomalous record pair to an outlier set;
grouping, by the one or more computer processors, the at least one first record pair and the at least one second record pair into clusters according to attribute comparison scores;
adding, by the one or more computer processors, at least two record pairs from a cluster to a cluster set; and
providing, by the one or more computer processors, the outlier and cluster sets to the user.

8. A computer program product for selecting entity matching system sample record pairs, the computer program product comprising one or more computer readable storage devices and collectively stored program instructions on the one or more computer readable storage devices, the stored program instructions comprising:
program instructions to select at least one first record pair from entity matching system data records;
program instructions to score attribute compare methods of the at least one first record pair according to the entity matching system;
program instructions to add the at least one first record pair to a no-match set according to the attribute compare method score;
program instructions to select at least one second record pair from an entity matching system data record bucket;
program instructions to score attribute compare methods of the at least one second record pair according to the entity matching system;
program instructions to add the at least one second record pair to a record pair set, according to the second record pair attribute compare method score; and
program instructions to provide the record pair set to a user.

9. The computer program product according to claim 8, the stored program instructions further comprising:
program instructions to identify an anomalous record pair among the at least one first record pair and the at least one second record pair;
program instructions to add the anomalous record pair to an outlier set; and
program instructions to provide the outlier set to the user.

10. The computer program product according to claim 8, the stored program instructions further comprising:
program instructions to group, the at least one first record pair and at the least one second record pair into clusters according to attribute comparison scores;
program instructions to add at least two record pairs from a cluster to a cluster set; and
program instructions to provide the cluster set to the user.

11. The computer program product according to claim 8, the stored program instructions further comprising program instructions to add a second record pair having an attribute compare score above an autolink threshold to a match set.

12. The computer program product according to claim 8, the stored program instructions further comprising program instructions to add a second record pair having an attribute compare score above a clerical threshold and below an autolink threshold, to a clerical set.

13. The computer program product according to claim 8, the stored program instructions further comprising program instructions to add at least one second record pair having an attribute compare score below a clerical threshold to the no-match set.

14. The computer program product according to claim 8, the stored program instructions further comprising:
program instructions to identify an anomalous record pair among the at least one first record pair and the at least one second record pair;
program instructions to add the anomalous record pair to an outlier set;
program instructions to group, the at least one first record pair and the at least one second record pair into clusters according to attribute comparison scores;
program instructions to add at least two record pairs from a cluster to a cluster set; and
program instructions to provide the outlier and cluster sets to the user.

15. A computer system for selecting entity matching system sample record pairs, the computer system comprising:
one or more computer processors;
one or more computer readable storage devices; and
stored program instructions on the one or more computer readable storage devices for execution by the one or more computer processors, the stored program instructions comprising:
program instructions to select at least one first record pair from entity matching system data records;
program instructions to score attribute compare methods of the at least one first record pair according to the entity matching system;
program instructions to add the at least one first record pair to a no-match set according to the attribute compare method score;
program instructions to select at least one second record pair from an entity matching system data record bucket;
program instructions to score attribute compare methods of the at least one second record pair according to the entity matching system;
program instructions to add the at least one second record pair to a record pair set, according to the second record pair attribute compare method score; and
program instructions to provide the record pair set to a user.

16. The computer system according to claim 15, the stored program instructions further comprising:
program instructions to identify an anomalous record pair among the at least one first record pair and the at least one second record pair;
program instructions to add the anomalous record pair to an outlier set; and
program instructions to provide the outlier set to the user.

17. The computer system according to claim 15, the stored program instructions further comprising:
program instructions to group, the at least one first record pair and at least one second record pair into clusters according to attribute comparison scores;
program instructions to add at least two record pairs from a cluster to a cluster set; and
program instructions to provide the cluster set to the user.

18. The computer system according to claim 15, the stored program instructions further comprising program instructions to add a second record pair having an attribute compare score above an autolink threshold to a match set.

19. The computer system according to claim 15, the stored program instructions further comprising program instructions to add a second record pair having an attribute compare score above a clerical threshold and below an autolink threshold, to a clerical set.

20. The computer system according to claim 15, the stored program instructions further comprising:
program instructions to identify an anomalous record pair among the at least one first record pair and the at least one second record pair;
program instructions to add the anomalous record pair to an outlier set;
program instructions to group, the at least one first record pair and the at least one second record pair into clusters according to attribute comparison scores;
program instructions to add at least two record pairs from a cluster to a cluster set; and
program instructions to provide the outlier and cluster sets to the user.
